(19) United States
(12) Patent Application Publication
(10) Pub. No.: US 2017/0364983 A1
(43) Pub. Date: Dec. 21, 2017

(54) CUSTOMIZED COLORED TIRES FOR VEHICLES

(71) Applicant: Timothy Adam Havard, Lucedale, MS (US)

(72) Inventor: Timothy Adam Havard, Lucedale, MS (US)

(21) Appl. No.: 15/697,784

(22) Filed: Sep. 7, 2017

(51) Int. Cl. G06Q 30/06; G05B 19/418; B60C 99/00; C08K 3/00; G06Q 10/08

(52) U.S. Cl. CPC G06Q 30/0621; C08K 3/0033; G06Q 10/087; B60C 99/006; G05B 19/41805; G05B 2219/45018; G05B 2219/31044

(57) ABSTRACT

A method and system for customizing vehicle tires based on a purchase order placed by a customer is disclosed. The customer is enabled to place the purchase order through one of a local store, a mail order and an online website. While placing the purchase order, the customer is enabled to provide the requirements regarding the color shade, areas to be colored etc., based on the color of the vehicle. The color shade in the purchase order is any one of primary colors or shades obtained by mixing primary colors excluding black. Once the purchase order is received, the color of the vehicle tires is customized based on the requirements provided by the customer.

### BACKGROUND

### Technical Field

The embodiments herein are generally related to vehicle tires. The embodiments herein are particularly related to customized vehicle tires. The embodiments herein are more particularly related to customizing color of vehicle tires for enhancing aesthetic appearance of vehicles.

### Description of the Related Art

Since known, color of vehicle tires produced worldwide is monochrome (black or gray). While purchasing a vehicle, even though we are allowed to choose color of vehicle from different available colors or get the body of the car customized by coloring in different shades of colors, generally the vehicle tires are always black. Until now, there is not known any colored vehicle tires manufactured in customized colors that goes coordinated with the color of the vehicle.

Traditional vehicle tires are black because of addition of carbon black to rubber used for manufacturing vehicle tires. The addition of carbon black to rubber makes the vehicle tires strong and durable. However, the black vehicle tires have certain drawbacks. With the black vehicle tires, it is difficult to notice any damage occurred, excessive or insufficient air pressure, excessive wear etc.

Hence, there is a need to customize a color of vehicle tires that is coordinated with the color of the vehicle. Further, there is a need for colored vehicle tires capable of indicating damages occurred, excessive or insufficient air pressure, excessive wearing etc. Furthermore, there is a need for customized vehicle tires that enhances the unique look of the vehicle, thereby highlighting the appearance of the vehicle.

The above-mentioned shortcomings, disadvantages, and problems are addressed herein and which will be understood by reading and studying the following specification.

### OBJECTS OF THE EMBODIMENTS HEREIN

The primary object of the embodiments herein is to customize a color of vehicle tires.

Another object of the embodiments herein is to customize color of vehicle tires that is coordinated with the color of vehicle or based on user choice.

Yet another object of the embodiments herein is to customize color of vehicle tires to enhance unique look of vehicle.

Yet another object of the embodiments herein is to customize color of vehicle tires based on a purchase order placed by a customer.

Yet another object of the embodiments herein is to customize color of vehicle tires using a solid color or a dual tone color based on a purchase order placed by a customer.

Yet another object of the embodiments herein is to provide colored vehicle tires configured to indicate excessive wearing, damages and excessive or insufficient air pressure.

Yet another object of the embodiments herein is to provide customized vehicle tires in all popular tire sizes.

Yet another object of the embodiments herein is to provide customized vehicle tires molded in different colors by coloring chemical composition of rubber used for manufacturing vehicle tires.

Yet another object of the embodiments herein is to provide colored vehicle tires that does not change color significantly with wear.

Yet another object of the embodiments herein is to provide customized vehicle tires colored with significantly striking colors for enabling better visual appearance, thereby providing alert to pedestrians and other vehicles on the road.

Yet another object of the embodiments herein is to customize color of vehicle tires by coloring the chemical composition of rubber using all primary color shades, excluding black.

Yet another object of the embodiments herein is to customize color of vehicle tires based on a purchase order placed by a customer either online or thorough a local store.

These and other objects and advantages of the embodiments herein will become readily apparent from the following detailed description taken in conjunction with the accompanying drawings.

### SUMMARY

The various embodiments herein provide a method and system for customizing color of vehicle tires based on a purchase order placed by a customer. The customer is enabled to place the purchase order through one of an online website, a mail order and a local store. The purchaser is provided with the vehicle tires customized by coloring as per the requirement mentioned in the purchase order.

According to an embodiment herein, a method for customizing color of a vehicle tire is disclosed. The method includes generating a purchase order by a customer through a website. The generation of the purchase order is initiated by providing details of vehicle. The method includes receiving a plurality of suggestions based on details of the vehicle. The plurality of suggestions includes color shades coordinated with the color of the vehicle. Further, the method includes placing the purchase order through the website. The purchase order comprises a plurality of color shades for customizing the vehicle tire, and required tire size. Furthermore, the method includes customizing the color of the vehicle tire by manufacturing the vehicle tire in the plurality of color shades and required tire size provided in the purchase order.

According to an embodiment herein, the details of vehicle includes but not limited to color of the vehicle and, model of the vehicle.

According to an embodiment herein, placing the purchase order further comprises placing the purchase order through one of a local store or a mail order.

According to an embodiment herein, the method of customizing the color of the vehicle tire further includes the steps of mixing the chemical composition of rubber using dyes and pigments corresponding to the plurality of color shades in the purchase order. Further, the method include steps of molding the rubber into shape of the vehicle tire. The rubber is molded into the required tire size mentioned in the purchase order.

According to an embodiment herein, the plurality of color shades required for customizing the vehicle tire includes but not limited a single solid color and a dual tone color.

According to an embodiment herein, customizing color of the vehicle tire using the single solid color is performed by coloring the tread, the inner side wall and the outer side wall using a same color shade.

According to an embodiment herein, customizing color of the vehicle tire using the dual tone color is performed coloring the tread using a first color shade and the inner side wall and the outer side wall using a second color shade.

According to an embodiment herein, customizing color of the vehicle tire in the plurality of color shades enhances the aesthetic appearance of the vehicle.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment and the accompanying drawings in which:

FIG. 1 illustrates a perspective view of a customized vehicle tire, according to one embodiment herein.

FIG. 2A illustrates a side view of a customized vehicle tire using a single solid color, according to one embodiment of the embodiments herein.

FIG. 2B illustrates a cross sectional view of a customized vehicle tire using a single solid color, according to one embodiment of the embodiments herein.

FIG. 3A illustrates a side view of a customized vehicle tire using a dual tone color, according to one embodiment of the embodiments herein.

FIG. 3B illustrates a cross sectional view of a customized vehicle tire using a dual tone color, according to one embodiment of the embodiments herein.

Although the specific features of the embodiments herein are shown in some drawings and not in others. This is done for convenience only as each feature may be combined with any or all of the other features in accordance with the embodiments herein.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method and system for customizing color of vehicle tires based on a purchase order placed by a customer. The customer is enabled to place the purchase order through one of an online website, a mail order and a local store. The purchaser is provided with customized vehicle tires colored as per the requirements mentioned in the purchase order.

According to an embodiment herein, a method for customizing color of a vehicle tire is disclosed. The method includes generating a purchase order by a customer through a website. The generation of the purchase order is initiated by providing details of vehicle. The method includes receiving a plurality of suggestions based on details of the vehicle. The plurality of suggestions includes color shades coordinated with the color of the vehicle. Further, the method includes placing the purchase order through the website. The purchase order comprises a plurality of color shades for customizing the vehicle tire, and required tire size. Furthermore, the method includes customizing the color of the vehicle tire by manufacturing the vehicle tire in the plurality of color shades and required tire size provided in the purchase order.

According to an embodiment herein, the details of vehicle includes but not limited to color of the vehicle and, model of the vehicle.

According to an embodiment herein, placing the purchase order further comprises placing the purchase order through one of a local store or a mail order.

According to an embodiment herein, the method of customizing the color of the vehicle tire further includes the steps of mixing the chemical composition of rubber using dyes and pigments corresponding to the plurality of color shades in the purchase order. Further, the method include steps of molding the rubber into shape of the vehicle tire. The rubber is molded into the required tire size mentioned in the purchase order.

According to an embodiment herein, the plurality of color shades required for customizing the vehicle tire includes but not limited a single solid color and a dual tone color.

According to an embodiment herein, customizing color of the vehicle tire using the single solid color is performed by coloring the tread, the inner side wall and the outer side wall using a same color shade.

According to an embodiment herein, customizing color of the vehicle tire using the dual tone color is performed coloring the tread using a first color shade and the inner side wall and the outer side wall using a second color shade.

According to an embodiment herein, customizing color of the vehicle tire in the plurality of color shades enhances the aesthetic appearance of the vehicle.

According to an embodiment herein, a method and system for customizing vehicle tires based on a purchase order placed by a customer is disclosed. The customer is enabled to place the purchase order through one of a local store, a mail order and an online website. The customer is enabled to provide the requirements regarding the color shade, areas to be colored etc. based on the color of the vehicle while placing the purchase order through the local store or the mail order. Further, while placing the purchase order though the online website, the customer is enabled to enter the requirements, preview images of the vehicle tire and make changes if required. The color shade in the purchase order is any one of primary colors or shades obtained by mixing primary colors, excluding black.

Once the purchase order is received, the color of the vehicle tires is customized based on the requirements provided by the customer. The color of the rubber used for manufacturing the vehicle tires is customized by pigmenting or dying the chemical composition of rubber. The rubber is further molded into shape of the vehicle tires having colors as per the requirements in the purchase order. The customized vehicle tires are further fitted on to the vehicle, thereby enhancing unique appearance of the vehicle.

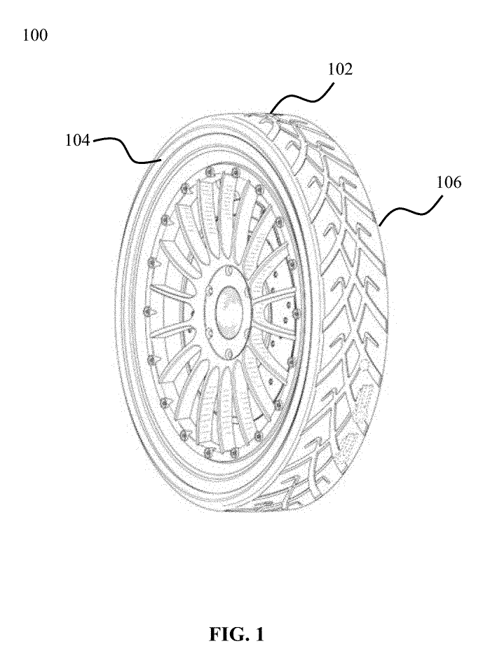

FIG. 1 illustrates a perspective view of a customized vehicle tire, according to one embodiment herein. The vehicle tire 100 comprises a tread 102, an outer side wall 104, and an inner sider wall 106. The outer side wall 104 connects the tread 102 with an outer bead and the inner side wall 106 connects the tread 102 with an inner bead of the vehicle tire 100. A plurality of parameters relating to the tread 102 including but not limited to width, depth and pattern is modified based on the need or to improve aesthetic appearance of the vehicle. A customer is enabled to place a purchase order for customizing the color of the tread 102, the outer side wall 104 and the inner side wall 106 of the vehicle tire 100.

The customer is enabled to place the purchase order through a local store, a mail order or an online website. While placing the purchase order through the local store and mail order, the customer needs to provide requirements including the color shades, area to be colored, required tire size etc. Further, while placing the purchase order through the online website, the customer needs to provide details of car including model of car, body color etc. The customer is provided with a plurality of suggestions for customizing the color of the vehicle tire 100. The plurality of suggestions includes different color shades that goes coordinated with the color of the vehicle. The user is enabled to choose from the plurality of suggestions and place the purchase order. The customer is enabled to preview images of the vehicle tire 100 customized with the color shade in the requirement, before placing the purchase order. The vehicle tire 100 is available in all popular tire sizes. The customer is enabled to choose the required tire size before pacing the purchase order. Once the purchase order is placed, the color of the vehicle tire 100 is customized based on the requirements provided by the customer.

The color shades for customizing the vehicle tire 100 in the requirement includes all primary colors and color shades obtained by mixing the primary colors, excluding black. The customer is also enabled to provide requirements for a single solid color or a dual tone color for customizing the vehicle tire 100. When a requirement of single solid color is provided, the tread 102, the outer side wall 104 and the inner side wall 106 of the vehicle tire 100 is colored with a same color shade mentioned in the requirement. When a requirement of a dual tone color is provided, the tread 102 is colored using a first color shade and the outer side wall 104 and the inner side wall 106 is colored with a second color shade mentioned in the requirement.

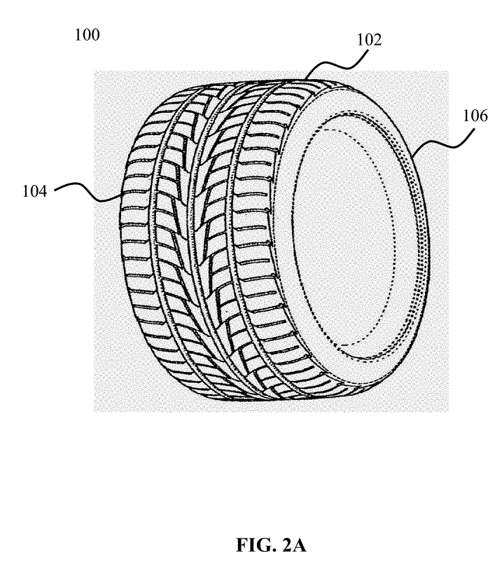

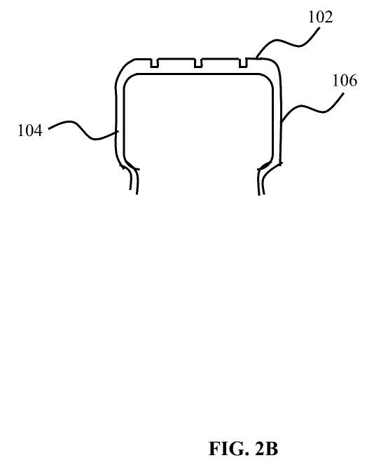

FIG. 2A illustrates a side view of a customized vehicle tire using a single solid color, according to one embodiment of the embodiments herein. FIG. 2B illustrates a cross sectional view of a customized vehicle tire using a single solid color, according to one embodiment of the embodiments herein. The vehicle tire 100 is customized using a single solid color in a particular tire size mentioned in a purchase order provided by a customer. The single solid color is chosen from any primary colors or color shade obtained by mixing the primary colors that goes coordinated with color of the vehicle. For customizing the vehicle tire 100 using the single solid color, chemical composition of rubber used for manufacturing the vehicle tire 100 is mixed with corresponding dyes and pigment.

For example, in order to customize the vehicle tire 100 in red color shade, the chemical composition of the rubber is mixed with dyes and pigments in red color shade. Further, the rubber is molded into shape of the vehicle tire 100 with the tire size mentioned in the purchase order. The vehicle tire 100 customized using red and other striking colors enables a customer to easily identify damages occurred, excessive wearing, excessive or insufficient air pressure of the vehicle tire etc.

While customizing with a single solid color, the tread 102, the outer side wall 104 and the inner side wall 106 appears in the same colors. The cross sectional view provided in FIG. 2B depicts that vehicle tire is uniformly colored across the thickness of the tread 102, the outer side wall 104 and the inner side wall 106. The vehicle tire is uniformly colored by coloring the chemical composition of the rubber uniformly with corresponding dyes and pigments. The uniform colors of vehicle tire does not fade with wear, thereby maintaining the aesthetic appearance of the vehicle.

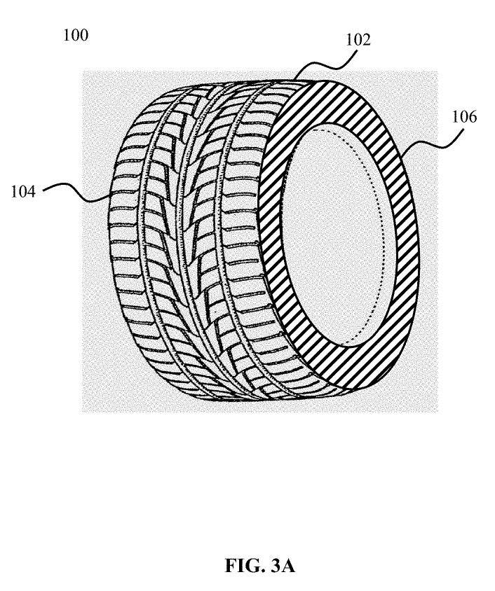

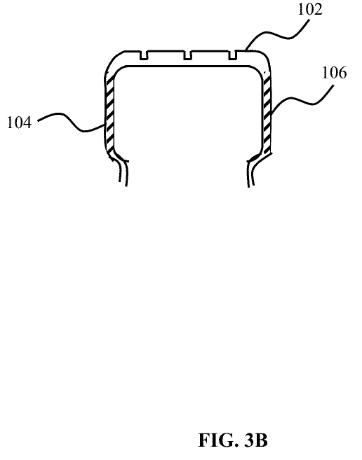

FIG. 3A illustrates a side view of a customized vehicle tire in a dual tone color, according to one embodiment of the embodiments herein. FIG. 3B illustrates a cross sectional view of a customized vehicle tire in a dual tone color, according to one embodiment of the embodiments herein. The vehicle tire 100 is customized using a dual tone color based on the requirements mentioned in a purchase order placed by a customer. The dual tone color comprises two shades of color for customizing the vehicle tire 100. The two shades of colors are chosen from the primary colors or the colors obtained by mixing the primary colors excluding black.

The user is enabled to mention the two shades of color in the requirement while placing a purchase order. The two shades of color is chosen such that it matches with the color of the vehicle. For customizing the vehicle tire 100 using two shades of color, chemical composition of rubber used for manufacturing the vehicle tire 100 is mixed with dyes and pigments corresponding to each colors. Once the chemical composition of the rubber is mixed with dyes and pigments, the rubber is molded into the shape of the vehicle tire 100. The rubber is molded such that the two shades of color appear on the vehicle tire 100.

For example, consider that the dual tone color mentioned in the requirement includes red and yellow shades of color. In order to manufacture the vehicle tire 100, the chemical composition of the rubber is mixed with dyes and pigments in red and yellow shades of color. The rubber is mixed with dyes and pigments in a proportion such that the tread 102 appears to be in red shade and the outer side wall 104 and the inner side wall 106 on both sides of the tread 102 appears to be in yellow shade while molding the rubber. The use of striking colors while manufacturing the vehicle tire 100 enables easy identification of excessive wear, damages and excessive or insufficient air pressure.

Further, cross sectional view provided in FIG. 3B illustrates that vehicle tire 100 is uniformly colored using the first shade of color across the thickness of the tread 102 and the second shade of color across the outer side wall 104 and the inner side wall 106. The vehicle tire is uniformly colored by coloring the chemical composition of the rubber uniformly with corresponding dyes and pigments. Therefore, vehicle tire 100 does not fade with wear, thereby maintaining the aesthetic appearance of the vehicle.

According to an embodiment herein, the vehicle tire 100 is customized using a plurality of color shades mentioned in the requirements in a purchase order. In order to manufacture the vehicle tire 100, using the plurality of color shades, the chemical composition of the rubber is mixed with dyes and pigments corresponding to each color. Further, the rubber is molded into the vehicle tire having a plurality of color shades.

Therefore, the embodiments herein provide a method of customizing the vehicle tire for improving the aesthetic appearance of the vehicle. The vehicle tire is customized using different colors that goes coordinated with the color of the vehicle. Thus, the customers are enabled to get rid of the traditional black vehicle tires and improve the unique look of the vehicle.

Further, customizing the vehicle tires using striking colors enables easy identification of damages occurred, excessive wear or excessive or insufficient air pressure. The use of striking colors also enables a mechanic to easily identify and fix the damages occurred to the vehicle tires. Furthermore, the use of striking colors for customizing the vehicle tires provides better visual appearance, thereby providing alert to pedestrians and other vehicles that a vehicle is on the road.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A method for customizing color of a vehicle tire, the method comprises:
generating a purchase order by a customer through a web site, wherein generation of the purchase order is initiated by providing details of vehicle;
receiving a plurality of suggestions based on details of the vehicle, wherein the plurality of suggestions includes color shades that matches with the color of the vehicle;
placing the purchase order through the website, wherein the purchase order comprises a plurality of color shades for customizing the vehicle tire, and required tire size; and
customizing the color of the vehicle tire by coloring a tread, an inner side wall and an outer side wall in the plurality of color shades and required tire size provided in the purchase order.

2. The method as claimed in claim 1, wherein the details of vehicle includes to color of the vehicle and, model of the vehicle.

3. The method as claimed in claim 1, wherein placing the purchase order further comprises placing the purchase order through one of a local store or a mail order.

4. The method as claimed in claim 1, wherein method of customizing the color of the vehicle tire further comprises the steps of:
mixing the chemical composition of rubber using dyes and pigments corresponding to the plurality of color shades indicated in the purchase order; and
molding the rubber into shape of the vehicle tire, and wherein the rubber is molded into the required tire size mentioned in the purchase order.

5. The method as claimed in claim 1, wherein the plurality of color shades required for customizing the vehicle tire includes a single solid color or a dual tone color.

6. The method as claimed in claim 1, wherein customizing color of the vehicle tire using the single solid color is performed by coloring the tread, the inner side wall and the outer side wall using a same color shade.

7. The method as claimed in claim 1, wherein step of customizing color of the vehicle tire using the dual tone color is performed coloring the tread using a first color shade and the inner side wall and the outer side wall using a second color shade.
